(19) United States
(12) Patent Application Publication
(10) Pub. No.: US 2009/0286115 A1
(43) Pub. Date: Nov. 19, 2009

(54) METHOD FOR AVOIDING GASEOUS IMPURITY INCLUSIONS IN AT LEAST ONE GAS CHAMBER OF A FUEL CELL DURING AN IDLE PERIOD AND FUEL CELL EQUIPPED WITH MEANS FOR CARRYING OUT THE METHOD

(76) Inventors: Frank BAUMANN, Mundelsheim (DE); Florian Wahl, Lohr (DE); Wolfgang Friede, Ludwigsburg (DE); Uwe Limbeck, Kirchheim Unter Teck (DE)

Correspondence Address: RONALD E. GREIGG;GREIGG & GREIGG P.L.L.C., 1423 POWHATAN STREET, UNIT ONE, ALEXANDRIA, VA, 22314, US

(21) Appl. No.: 12/254,997

(22) Filed: Oct. 21, 2008

(30) Foreign Application Priority Data
Oct. 31, 2007 (DE) 10 2007 052 148.2

(51) Int. Cl. H01M 8/04; H01M 2/02

(52) U.S. Cl. 429/17; 429/34; 429/22

(57) ABSTRACT

A method and apparatus are provided for avoiding gaseous impurity inclusions in at least one gas chamber of a fuel cell during an idle period of the fuel cell through the production of a positive pressure in the at least one gas chamber. The method includes the steps producing educts that are supplied to the fuel cell for operation of the fuel cell during an operating mode, supplying the educts to the gas chamber so that the gas chamber is at least partially filled with the educts, and filling the gas chamber to produce a positive pressure in the gas chamber and thereby essentially avoiding gaseous impurity inclusions.

### CROSS-REFERENCE TO RELATED APPLICATIONS

This application is based on German Patent Application No. 10 2007 052 148.2 filed on Oct. 31, 2007, upon which priority is claimed.

### BACKGROUND OF THE INVENTION

1. Field of the Invention

The invention relates to a method for avoiding gaseous impurity inclusions in at least one gas chamber of a fuel cell during an idle period of the fuel cell. The invention also relates to a fuel cell that includes at least two electrode devices, an electrolyte element situated between electrode devices, and at least one educt line for conveying gaseous substances into and out of the fuel cell, which includes at least one corresponding gas chamber.

2. Description of the Prior Art

There are known methods and fuel cell devices of this kind that protect gas chambers, which are required for operation, from damage due to the presence of impurity inclusions. During an idle period of the fuel cell, it is not possible to hermetically seal these gas chambers so that as time passes, if additional steps are not carried out, then the gas chambers of the fuel cell become filled with gases such as air that seep in. When switching into an operating mode of the fuel cell, the reaction gases are introduced into the gas chambers that also still contain the gaseous impurity inclusions. As a result of this, at certain times, the impurity inclusions—the air—and the reaction gases are simultaneously present at various locations on the anode in a flow field of the fuel cell. As a result, potentials are present at the cathode, which produce corrosion effects that in turn result in an accelerated deterioration of the cathode. In the prior art, this problem is solved in that when the fuel cell is switched into the operating mode, an inert gas is fed into the gas chambers before the reaction gas flows in. This makes it possible to avoid the damaging potentials. However, the supply of inert gas requires an additional expense, which, particularly for a mobile application such as a motor vehicle, results in a very high additional expense and requires an enormous amount of space and therefore can only be implemented to an unsatisfactory degree.

### OBJECT AND SUMMARY OF THE INVENTION

The object of the present invention, therefore, is to create a method and a fuel cell, which, with a low expense and with a simple structure, avoid gaseous impurity inclusions in gas chambers of the fuel cell, particularly during an idle mode of the fuel cell.

The invention includes the technical teaching of a method for avoiding gaseous impurity inclusions in at least one gas chamber of a fuel cell during an idle period of the fuel cell, by producing a positive pressure in the at least one gas chamber, including the steps of:
production, through the supply of energy, of educts that are supplied to the fuel cell for its operation during an operating mode,
supply of the educts for the filling of the gas chamber so that it is at least partially filled with the educts, and
filling of the gas chamber so that a positive pressure is produced in the gas chamber and gaseous impurity inclusions are essentially avoided.

The fuel cell basically includes two electrode plates; one electrode plate is an anode plate and the other electrode plate is a cathode plate. These plates are separated from each other by an electrolyte element. If several fuel cells are combined into a fuel cell stack, then the electrode plates are embodied in the form of so-called bipolar plates, which include both the anode plate and also the cathode plate in a single unit. The electrode plates such as the bipolar plates are embodied as electrically conductive.

The fuel cell essentially functions in accordance with the following principle: in the fuel cell, two educts, for example hydrogen and oxygen, react with each other to form a product, for example water, in the process of which energy is produced. The educts—in this case the two gases hydrogen and oxygen—are separated from each other by an electrolyte element and exchange electrons via an electric conductor. This electron flow permits the fuel cell to function as a current source during its operating mode. Correspondingly, no current is produced in an idle mode of the fuel cell. The fuel cell or more precisely stated, the electric plates, has so-called gas chambers that contain the gaseous educts in the operating mode. In the idle mode, the method according to the invention is used to prevent gaseous impurities such as ambient air, which diffuses into the cell, from flowing into the gas chambers. This is achieved through the production of a positive pressure in the gas chambers during an idle period so that no ambient air can diffuse into the gas chambers from the outside.

In order to produce a positive pressure and keep the gas chamber or chambers free of gaseous impurity inclusions, in the idle mode, first the educts are produced, which are supplied for the production of the product and the energy in the operating mode of the fuel cell. For example, the educts can be hydrogen and oxygen. Advantageously, these educts—which are used during the operating mode to produce current with the fuel cell—are produced during the idle mode so that no substances that are uninvolved in the reaction are present in the gas chambers. The educts are obtained through the supply of energy. Although the educts are actually the products of the reaction in the idle mode, the term educts is used here to make it clear that the substances produced constitute the educts in the operating mode. Consequently, the educts in the operating mode correspond to the products in the idle mode and the products in the operating mode correspond to the educts in the idle mode. This makes it clear that the reaction for producing a positive pressure in the idle mode is essentially the reverse of the reaction in the operating mode. After the educts are produced, they are supplied to the gas chamber in order to correspondingly fill it. The gas chamber is filled until a positive pressure occurs in the gas chamber in comparison to the ambient pressure. Due to the presence of the positive pressure, is not possible for gaseous impurities to diffuse into the gas chamber, thus keeping the gas chamber free of gaseous impurity inclusions.

In one embodiment, the step of avoiding gaseous impurity inclusions in the gas chamber includes the displacement of gaseous impurity inclusions. If gaseous impurity inclusions are already present in the gas chamber, then these are displaced from the gas chamber by the supplied educts, for example hydrogen and oxygen, so that the gas chamber is once again free of impurity inclusions. This fills the gas chamber so that once again, a slight positive pressure is produced in comparison to the ambient pressure. Generally speaking, the positive pressure can be only minimal, i.e. only a few mbar or hPa greater than the ambient pressure.

In another embodiment, the step of producing the educts occurs through a regulated electrolysis. In this case, a chemical compound such as water is split through the action of an electrical current. The electrolysis in this case represents the reverse principle of the fuel cell. The electrolysis is regulated in accordance with the requirements by suitable regulators. In principle, a structure similar to a fuel cell is required so that through a suitable regulation, the electrolysis can occur in the fuel cell itself. For this reason, in one embodiment, the step of producing the educts occurs internally in the fuel cell through reversal of the principle on which fuel cell operates in its operating mode. In other words, in the idle mode, the function of the fuel cell is reversed so that it can carry out the electrolysis. The functions are correspondingly reversed by a control unit, in particular through the supply of energy and material. The energy previously produced during the operating mode can be used in the idle mode to produce the educts for the operating mode. Alternatively, however, it is also possible to use a separate device by which the educts can be produced.

To this end, in another exemplary embodiment, the step of producing the educts is carried out externally, i.e. outside the fuel cell. Naturally, the two methods can also be combined.

The invention also includes the technical teaching that in a fuel cell, including at least two electrode devices, an electrolyte element situated between the electrode devices, and at least one educt line for conveying gaseous substances into and out of the fuel cell equipped with at least one corresponding gas chamber, the fuel cell has a mechanism for avoiding gaseous impurity inclusions in the gas chamber during an idle mode of the fuel cell. The mechanism is embodied for carrying out the previously described method of the invention.

The electrode devices are embodied in the form of an anode, for example an anode plate, and a cathode, for example a cathode plate. Between these, an electrolyte element is provided, which can, for example, be an electrolyte membrane, in particular a polymer electrolyte membrane (PEM) or the like.

In one embodiment, the mechanism include a pressure device for producing positive pressure in the fuel cell in order to displace gaseous impurity inclusions. The pressure device produces a positive pressure in the gas chamber so that no gaseous impurities can penetrate or diffuse into the gas chamber from the outside. The positive pressure produced here can be only minimally greater than the ambient pressure. The pressure device is embodied so that it produces the positive pressure during the idle mode. The positive pressure here is maintained for the entire duration of the idle mode. The production of this positive pressure is terminated only after the switch to the operating mode. In one embodiment, the positive pressure is produced through the supply and/or production of educts.

In another embodiment of the invention, the pressure device includes an electrolysis unit in order to produce a positive pressure in the fuel cell during the idle mode through the production of educts that can be supplied to the fuel cell in the operating mode. In order to produce a positive pressure in the gas chamber or chambers during the idle mode of the fuel cell, an electrolysis unit produces the educts for the operating mode during the idle mode. In this case, the active principle of the fuel cell is reversed. Thus for example, in the idle mode, hydrogen and oxygen are produced from water and energy. These educts of the operating mode are supplied to the gas chambers so that they produce a positive pressure there in comparison to the ambient pressure, thus displacing or avoiding gaseous impurity inclusions.

For this reason, in one exemplary embodiment, the electrolysis unit has a supply for a product from the operating mode of the fuel cell, an energy supply, and an electrolyzer for carrying out the electrolysis and producing the educts for the operating mode of the fuel cell. The supply for the product of the operating mode, for example water, can include a reservoir, lines, delivery devices such as pumps, throttles, valves, and other supply devices. This supply can be embodied in the form of a recirculation circuit or can also be embodied in the form of an open line system with an inlet and outlet. The supply has corresponding regulating devices, which regulate the valves, throttles, etc., i.e. the supply as a whole. The energy supply can have a current source such as a battery, a fuel cell, a power grid connection, or the like. The energy supply can also include regulators, converters, and other regulating, measuring, and control devices for regulating the energy supply. The electrolyzer is a device that uses electrolysis to break down water into its base components, i.e. hydrogen and oxygen. The electrolyzer can be embodied in the form of an alkaline electrolyzer, a PEM electrolyzer, or a high-temperature electrolyzer, etc.

In one embodiment, the electrolyzer uses the electrode devices situated inside the fuel cell, an electrolyte element, and a regulating device to reverse the function of the fuel cell in order, by reversing the fuel cell principle, to permit two educts to be obtained from the corresponding product through the use of energy. In this case, the electrolysis occurs inside the fuel cell. In another embodiment, the electrolyzer uses electrodes situated outside the fuel cell, an electrolyte layer, and a regulating device in order to carry out the electrolysis. In this case, the electrolysis occurs outside the fuel cell.

During the idle mode, the principle of the fuel cell is reversed. In this case, hydrogen is produced by electrolysis in the fuel cell or in a separate device. The energy for this is supplied by an energy supply, for example a vehicle battery, or in hybrid vehicles, the drive battery. With this method, a fuel cell stack can be maintained at a slight positive pressure in relation to the ambient pressure so that no gas can penetrate it from the outside. At the same time, through the supply of the hydrogen and oxygen produced in the electrolysis, it is possible to compensate for the diffusion of gases through the membrane.

All of the gas inlet lines and outlet lines can be closed by valves. The outlet lines contain a throttle that permits a slow escape of gas when the pressure in the fuel cell stack is greater than the ambient pressure. In the second embodiment, a voltage is applied to the stack so that an electrolysis reaction occurs in the catalyst of the stack. As a result, hydrogen and oxygen are produced in the stack. Water is supplied to the cathode side as an educt for the electrolysis. In the first embodiment, the electrolysis does occur in a corresponding fashion, but not through the use of the catalyst in the stack. In this case, an external catalyst module is used, for example likewise a catalyst that is based on PEM technology. It is possible for this module to be structurally integrated into the stack. The arrangement will function with reversible stacks. In both cases, the required positive pressure is produced by the electrolysis. The amount of energy required can be kept relatively low if the arrangement is embodied as correspondingly sealed. If the device is used in a motor vehicle, then the water required for the electrolysis can be produced from the product water during driving. A longer idle period can end up draining both the battery and the water reservoir, either requiring the operation to be switched off again, i.e. the arrangement is only able to eliminate the results of short idle periods, or requiring the fuel cell to be automatically switched on briefly in order to produce current and water. The water is stored in a reservoir from which it can be supplied to the electrolysis. This reservoir can be electrically heated in order to prevent it from freezing. As a possible embodiment, in addition to or in lieu of the above-mentioned throttle, the pressure can be maintained via a definite current draw from the fuel cell. This drawn energy can be returned to the battery, thus reducing the overall current consumption. In another embodiment, a control is executed using a model-based approach, which also makes it possible to eliminate the throttle. The electrolysis outside the stack can be carried out by electrolyzers that have already been developed. One embodiment variant is a partitioned stack, thus making it possible to implement a combination of the two arrangements.

Other measures that improve the invention ensue from the following description of two exemplary embodiments of the invention that are schematically depicted in the figures. All of the defining characteristics and/or advantages, including structural details, spatial arrangements, and method steps arising from the description or the drawings can be essential to the invention individually or also in an extremely wide variety of combinations with one another.

### BRIEF DESCRIPTION OF THE DRAWINGS

The invention will be better understood and further objects and advantages thereof will become more apparent from the ensuing detailed description of preferred embodiments taken in conjunction with the drawings. In which:

FIG. 1 schematically depicts a wiring diagram of a layout of a first embodiment of a fuel cell with external electrolysis; and

FIG. 2 schematically depicts a wiring diagram of a layout of a second embodiment of a fuel cell with internal electrolysis.

### DESCRIPTION OF THE PREFERRED EMBODIMENTS

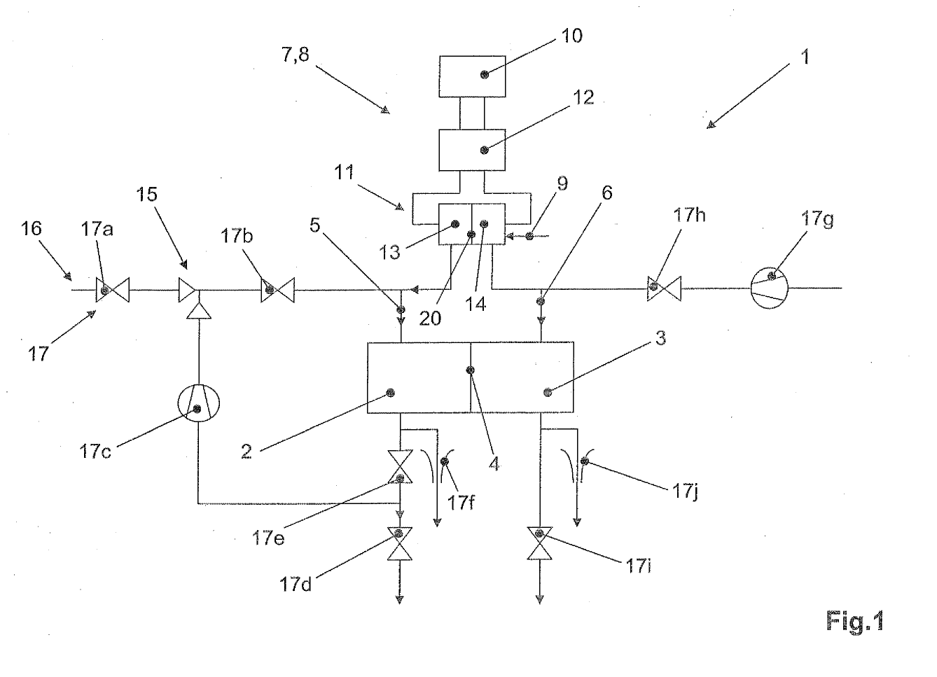

FIG. 1 schematically depicts a wiring diagram of a layout of a first embodiment of a fuel cell 1 with external electrolysis. The fuel cell 1 includes two electrode devices 2, 3: a first electrode device 2 embodied in the form of an anode and a second electrode device 3 embodied in the form of a cathode. The fuel cell 1 also includes an electrolyte element 4, which is situated between the anode 2 and the cathode 3. An educt line 5, 6 leads to each of the electrode devices 2, 3. The corresponding educt is supplied to the anode 2 and the cathode 3, respectively, via the corresponding educt line 5, 6. In the operating mode, the educt line 5 supplies the anode 2 with a combustion gas, e.g. hydrogen, and the educt line 6 supplies the cathode 3 with another combustion gas, e.g. oxygen. The educt lines 5, 6 and the electrode devices 2, 3 contain corresponding gas chambers in which the corresponding educts can be contained.

In order to now prevent the gaseous impurities in the gas chambers, for example due to ambient air diffusing into them, the fuel cell 1 has a pressure device 7, which produces a positive pressure in the fuel cell 1, or more precisely stated in the gas chambers, in comparison to the ambient pressure.

The pressure device 7 includes an electrolysis unit 8, which produces the educts of the operating mode of the fuel cell in the idle mode of the fuel cell 1. Through a supply of these educts into the fuel cell, a positive pressure is produced in the fuel cell. The electrolysis unit 8 includes a supply 9 for a product, an energy supply 10, and an electrolyzer 11 for carrying out the electrolysis. Via the supply 9, the electrolyzer 11 is supplied with a product, for example water. Via the energy supply 10, the electrolyzer 11 is supplied with the energy required for the electrolysis. A regulator 12 such as a power electronics control element (e.g. an AC/DC or DC/DC converter) or the like can be provided for regulating the electrolysis. The electrolyzer 11 includes an anode unit 14 and a cathode unit 13 at which hydrogen (cathode) and oxygen (anode) are produced. The hydrogen and oxygen are fed into a corresponding line system 15 and supplied to the fuel cell via the corresponding educt lines 5, 6. In addition to the corresponding lines 16, the line system 15 also includes additional line elements 17 such as throttles, compressors, pumps, valves, and the like. In addition to the anode unit 13 and the cathode unit 14, the electrolyzer 11 also has an electrolyte layer 20.

The line system 15 is constructed as follows. When the valves 17 a, b, and e are open, a combustion gas such as hydrogen is supplied from a reservoir via a line 16 and travels through the valves 17a and 17b to the anode 2. Unused hydrogen is conveyed through the valve 17e to the compressor 17c, which conveys the hydrogen back to the fuel cell 1 via the valve 17b. This feedback is also referred to as recirculation. The compressor 17c is just one example of a possible embodiment. It is also conceivable to use a Venturi nozzle for the recirculation. In order to avoid an accumulation of impurities such as inert gases during operation, gas is vented to the environment via the valve 17d in a controlled, either periodic or continuous, fashion. As a rule, the throttle 17f is closed during operation.

The valves 17h and 17i are open during operation. An oxidant, e.g. air or oxygen, flows from the air compressor 17g to the cathode 3. Unused oxidant passes through the valve 17i into the environment. During operation, as little air as possible should exit through the throttle 17j, which is why the throttle 17j should also be closed during operation. During the idle period the valves 17b, 17e, 17h, and 17i separate the fuel cell 1 from the environment. The electrolyzer 11 conveys a combustion gas into the interior of the fuel cell. In this case, the throttles 17f and 17j can be opened and used for pressure maintenance.

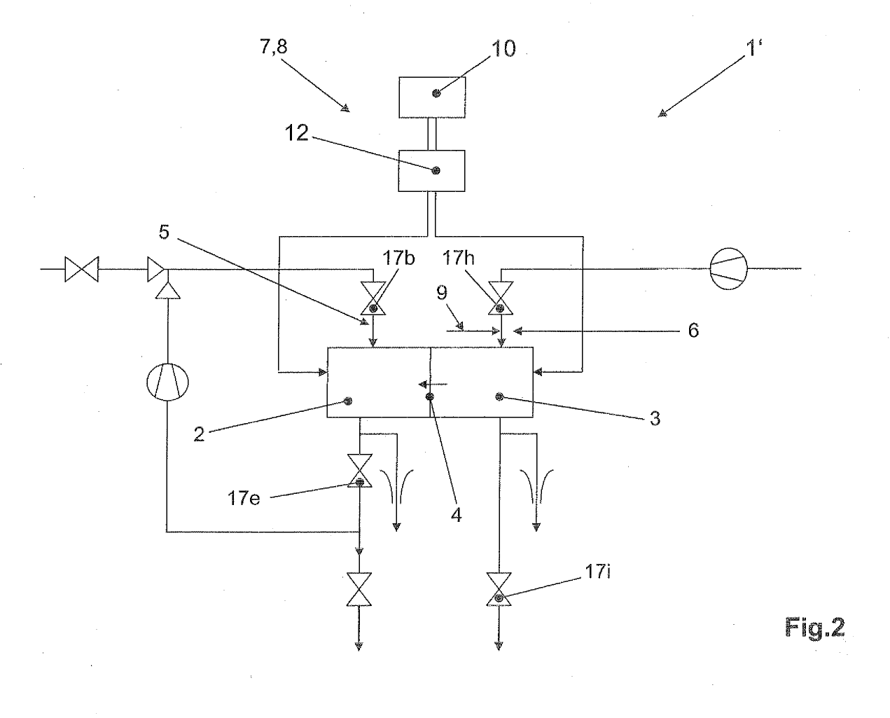

FIG. 2 schematically depicts a wring diagram of a layout of a second embodiment of a fuel cell 1′ with internal electrolysis. The fuel cell 1′ includes two electrode devices 2, 3: a first electrode device 2 functioning as an anode during the operating mode and a second electrode device 3 functioning as a cathode in the operating mode. In the idle mode, the functions of the electrode devices 2, 3 are reversed. The fuel cell 1′ also includes an electrolyte element 4, which is situated between the electrode devices 2, 3. A respective educt line 5, 6 leads to the electrode devices 2, 3 and with the educt line 6 is able to supply both oxygen and water to the electrode device 3. The corresponding educt line 5, 6 supplies the corresponding educt to or from the anode 2 and the cathode 3, respectively. During the operating mode, the educt line 5 supplies hydrogen to the anode 2 and the educt line 6 supplies oxygen to the cathode 3. In the idle mode, the valves 17 b, e, h, i close, thus separating the fuel cell from the environment so that no gases are supplied to it. Instead, hydrogen and oxygen are produced by means of electrolysis in the electrode devices. To this end, water is supplied via the educt line 6 when the valve 17h is closed. Through the energy supply 10, regulated by means of the regulator 12, a voltage is applied to the two electrode devices 2, 3. As a result, the fuel cell 1′ is operated as an electrolysis unit 11 and hydrogen and oxygen are produced from the water.

The fuel cell 1′, according to FIG. 2 essentially differs from the fuel cell 1 shown in FIG. 1 in that no external electrolyzer is used and the supply 9 correspondingly feeds directly into the line system 15. Also, the energy supply 10 is correspondingly routed not to the external electrolyzer 11, but to the electrode devices 2, 3 instead.

The educt lines 5, 6 and the electrode devices 2, 3 contain corresponding gas chambers in which the corresponding educt can be contained. In order to avoid gaseous impurities in the gas chambers, for example due to ambient air diffusing into them, the fuel cell 1′ has a pressure device 7, which is integrated into the fuel cell and produces a positive pressure in the fuel cell 1′, or more precisely stated in the gas chambers, in comparison to the ambient pressure. The pressure device 7 includes an electrolysis unit 8, which produces the educts of the operating mode of the fuel cell during the idle mode of the fuel cell 1′. The electrolysis unit 8 includes a supply 9 for a product, an energy supply 10 and an internal electrolyzer (not numbered) for carrying out the electrolysis. Via the supply 9, the electrolyzer is supplied with a product, for example water. Via the energy supply 10, the electrolyzer is supplied with the energy required for the electrolysis. A regulator 12 such as a DC/DC converter or the like can be provided for regulating the electrolysis. The electrolyzer includes the first electrode device 2 and the second electrode device 3 at which hydrogen (cathode) and oxygen (anode) are produced. The hydrogen and oxygen are fed into a corresponding line system (not numbered) and into the gas chambers of the fuel cell 1′ and when the operating mode is switched on, are conveyed out of the fuel cell 1′ via the corresponding educt lines 5, 6. The line system is embodied in a form analogous to the one in FIG. 1 and in addition to the corresponding lines, also includes additional line elements such as throttles, compressors, pumps, valves, and the like.

The foregoing relates to preferred exemplary embodiments of the invention, it being understood that other variants and embodiments thereof are possible within the spirit and scope of the invention the latter being defined by the appended claims.

We claim:

1. A method for avoiding gaseous impurity inclusions in at least one gas chamber of a fuel cell during an idle period of the fuel cell through the production of a positive pressure in the at least one gas chamber, comprising the steps of:
producing, through the supply of energy, educts that are supplied to the fuel cell for operation of the fuel cell during an operating mode,
supplying the educts to the gas chamber so that the gas chamber is at least partially filled with the educts, and
filling the gas chamber to produce a positive pressure in the gas chamber and thereby essentially avoiding gaseous impurity inclusions.

2. The method as recited in claim 1, wherein the step of avoiding gaseous impurity inclusions in the gas chamber includes displacing gaseous impurity inclusions.

3. The method as recited in claim 1, wherein the step of producing educts occurs through a regulated electrolysis.

4. The method as recited in claim 2, wherein the step of producing educts occurs through a regulated electrolysis.

5. The method as recited in claim 1, wherein the step of producing educts occurs internally in the fuel cell through reversal of the fuel cell principle in the operating mode.

6. The method as recited in claim 2, wherein the step of producing educts occurs internally in the fuel cell through reversal of the fuel cell principle in the operating mode.

7. The method as recited in claim 3, wherein the step of producing educts occurs internally in the fuel cell through reversal of the fuel cell principle in the operating mode.

8. The method as recited in claim 1, wherein the step of producing educts occurs externally, outside the fuel cell.

9. The method as recited in claim 2, wherein the step of producing educts occurs externally, outside the fuel cell.

10. The method as recited in claim 3, wherein the step of producing educts occurs externally, outside the fuel cell.

11. A fuel cell, comprising:
at least two electrode devices;
an electrolyte element situated between the electrode devices;
at least one educt line for conveying gaseous substances into or out of the fuel cell;
at least one gas chamber corresponding to each educt line; and
means for avoiding gaseous impurity inclusions in the gas chamber during an idle mode of the fuel cell.

12. The fuel cell as recited in claim 11, wherein the means include a pressure device for producing positive pressure in the fuel cell in order to displace gaseous impurity inclusions.

13. The fuel cell as recited in claim 11, wherein the pressure device includes an electrolysis unit in order to produce a positive pressure in the fuel cell in the idle mode through the production of educts which are possible to convey to the fuel cell in the operating mode.

14. The fuel cell as recited in claim 12, wherein the pressure device includes an electrolysis unit in order to produce a positive pressure in the fuel cell in the idle mode through the production of educts which are possible to convey to the fuel cell in the operating mode.

15. The fuel cell as recited in claim 11 wherein the electrolysis unit has a supply for a product during the operating mode of the fuel cell, an energy supply, and an electrolyzer for carrying out the electrolysis and producing the educts during the operating mode of the fuel cell.

16. The fuel cell as recited in claim 12, wherein the electrolysis unit has a supply for a product during the operating mode of the fuel cell, an energy supply, and an electrolyzer for carrying out the electrolysis and producing the educts during the operating mode of the fuel cell.

17. The fuel cell as recited in claim 13, wherein the electrolysis unit has a supply for a product during the operating mode of the fuel cell, an energy supply, and an electrolyzer for carrying out the electrolysis and producing the educts during the operating mode of the fuel cell.

18. The fuel cell as recited in claim 1, wherein the electrolyzer is equipped with the electrode devices situated inside the fuel cell, an electrolyte element, and a regulating device for reversing the function of the fuel cell in order, by reversing the fuel cell principle, to implement a production of two educts from the corresponding product through the use of energy.

19. The fuel cell as recited in claim 12, wherein the electrolyzer is equipped with the electrode devices situated inside the fuel cell, an electrolyte element, and a regulating device for reversing the function of the fuel cell in order, by reversing the fuel cell principle, to implement a production of two educts from the corresponding product through the use of energy.

20. The fuel cell as recited in claim 11, wherein the electrolyzer is equipped with electrodes situated outside the fuel cell, an electrolyte layer, and a regulating device in order to carry out the electrolysis.
